(19) United States
(12) Patent Application Publication
(10) Pub. No.: US 2010/0322433 A1
(43) Pub. Date: Dec. 23, 2010

(54) ACTIVE NOISE CANCELLATION EARPHONE

(76) Inventor: Ming-Jane HSIEH, HsinChu (TW)

Correspondence Address: Muncy, Geissler, Olds & Lowe, PLLC, 4000 Legato Road, Suite 310, FAIRFAX, VA, 22033, US

(21) Appl. No.: 12/816,806

(22) Filed: Jun. 16, 2010

(30) Foreign Application Priority Data
Jun. 17, 2009 (TW) 98120286

(51) Int. Cl. G10K 11/16

(52) U.S. Cl. 381/71.8

(57) ABSTRACT

An active noise cancellation (ANC) earphone for coupling to a host having a first jack and a second jack includes a sound source module, a sensing source module, a first connection module, and a second connection module. The sound source module is used for playing an audio signal. The sensing source module is coupled to the sound source module for sensing a noise near the sound source module. The first connection module has one end coupled to the sound source module and the other end inserted in the first jack, for transferring the audio signal generated by the host to the sound source module. The second connection module has one end coupled to the sensing source module and the other end inserted in the second jack, for transferring the noise sensed by the sensing source module to the host to generate a suppression signal for cancelling the noise.

### CROSS-REFERENCES TO RELATED APPLICATIONS

This non-provisional application claims priority under 35 U.S.C. §119(a) on Patent Application No. 98120286 filed in Taiwan, R.O.C. on 2009 Jun. 17, the entire contents of which are hereby incorporated by reference.

### BACKGROUND

1. Technical Field

The disclosure relates to an earphone, and more particularly to an active noise cancellation (ANC) earphone.

2. Related Art

An earphone has many advantages. For example, it enables listening to music without influencing people nearby, and also blocks ambient noise, which is of great help to people working in an environment such as a recording room or a broadcasting station. The earphone is a pair of conversion units designed to receive an electronic signal sent by a playing device, which then converts the electronic signal into a sound wave audible to human ears using a speaker close to the ears. With the prevalence of electronic devices, the earphone can be applied in a wide range of fields; for example, mobile phones, music players, video game devices, or computers.

With the development of science and technology, a so-called ANC earphone has emerged on the market. The aim of ANC technology is to cancel the noise may heard by user when using the earphone. In general approach, a receiving end (microphone) of the ANC earphone receives a noise from the environment, and an ANC circuit generates a corresponding cancellation signal according to the received noise and transfers the cancellation signal to a speaker of the earphone. In this way, even high levels of ambient noise (for example, the sound of a plane engine in a long-distance flight or the noise of a train), can be effectively suppressed through the ANC earphone, thus providing the user with high-quality audio playing.

However, in most of ANC earphones, a circuit and a power supply required for ANC are connected to the earphone, that is, the earphone must be charged or have a battery attached. Since most of the ANC earphones integrate the ANC circuit, the battery, and the earphone in one unit, they are quite expensive.

As a result, the design of separating the earphone from the ANC circuit has emerged in the market, in which an ANC circuit is moved to a sound source host, and the ANC earphone itself only provides the earphone and a microphone. In this way, the cost of the whole ANC earphone is definitely reduced, but another problem arises. Since the ANC earphone must also provide the function of receiving a noise in addition to the function of playing sounds so as to suppress the noise according to the received noise, in such an ANC earphone design a connector header at the terminal of the connecting line thereof is a five-stage earphone connector, and the five stages of signals are respectively left output, right output, left input, right input, and ground.

Since general earphones are mostly separated from sound source hosts, a connector header of an earphone is inserted in a jack of a sound source host to achieve the connection there-between. Moreover, the connector header on the general earphone and the jack corresponding to the sound source host are both standardized, and are currently standardized as both three-stage connector header and jack. Therefore, although this new design can reduce the price of the ANC earphone, the earphone connector can only be connected to a corresponding purpose-made jack (five-stage), instead of most current sound source hosts, due to its non-standardized (three-stage), design, which is inconvenient to use.

### SUMMARY

With this in mind, the disclosure is directed to an ANC earphone. With the earphone in the disclosure, an ANC circuit is moved to a host providing an audio signal, and a standardized design of three-stage earphone connector header is used. In this way, the purpose of reducing the cost and price of the earphone can be achieved without considering a special jack design; moreover, the earphone can be connected to various standardized hosts for receiving audio signals.

The disclosure provides an ANC earphone for coupling to a host having a first jack and a second jack. The ANC earphone includes a sound source module, a sensing source module, a first connection module, and a second connection module. The sound source module is used for playing an audio signal. The sensing source module is coupled to the sound source module for sensing a noise near the sound source module. The first connection module has one end coupled to the sound source module and the other end inserted in the first jack, for transferring the audio generated by the host to the sound source module. The second connection module has one end coupled to the sensing source module and the other end inserted in the second jack, for transferring the noise sensed by the sensing source module to the host to generate a suppression signal corresponding to the noise for cancelling the noise.

The preferred embodiments and efficacy of the disclosure will be illustrated below with reference to the drawings.

### BRIEF DESCRIPTION OF THE DRAWINGS

The disclosure will become more fully understood from the detailed description given herein below for illustration only, and thus not limitative of the disclosure, wherein:

FIG. 1 is a first block diagram of an ANC earphone according to an embodiment;

FIG. 2 is a second block diagram of an ANC earphone according to an embodiment; and

FIG. 3 is a schematic view of an ANC earphone according to an embodiment.

### DETAILED DESCRIPTION

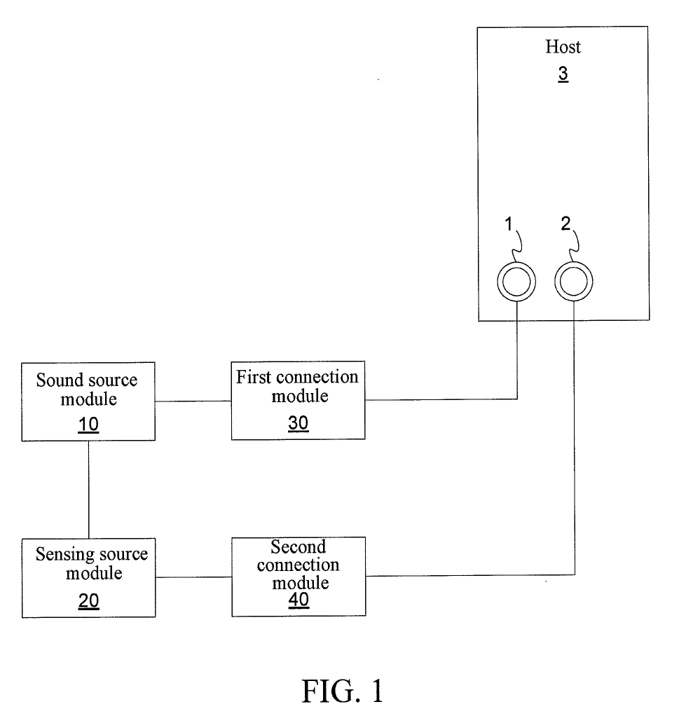

FIG. 1 is a first block diagram of an ANC earphone according to an embodiment. The ANC earphone provided in the disclosure is used for coupling to a host 3 having a first jack 1 and a second jack 2. The ANC earphone includes a sound source module 10, a sensing source module 20, a first connection module 30, and a second connection module 40.

The sound source module 10 is used for playing an audio signal. The sensing source module 20 is coupled to the sound source module 10 for sensing a noise near the sound source module. The first connection module 30 has one end coupled to the sound source module 10 and the other end inserted in the first jack 1 of the host 3, for transferring the audio generated by the host 3 to the sound source module 10. The second connection module 40 has one end coupled to the sensing source module 20 and the other end inserted in the second jack 2 of the host 3, for transferring the noise sensed by the sensing source module 20 to the host 3.

The host 3 may be a computer (PC) or a consumer electronic (CE) product. The host 3 referred to in the disclosure is electronic device having jacks into which the earphone may be inserted. In the disclosure, an ANC circuit is disposed in the host 3. Taking a computer system as an example for purposes of illustration, the computer system has an audio codec for performing an operation on an audio signal. The disclosure proposes the arrangement of the ANC circuit in the audio codec, so that only the ANC earphone provided in the disclosure itself must have the sound source module 10 for playing an audio, the sensing source module 20 for sensing a noise, and the first connection module 30 and the second connection module 40 for connection to the host 3, which may greatly reduce the cost and price of the entire ANC earphone.

When the sensing source module 20 senses the noise near the sound source module 10 and transfers the noise to the back-end host 3, the host 3 can provide an appropriate operation through the ANC circuit disposed therein, for example, provide an inverted suppression signal according to the noise sensed by the sensing source module 20, and then transfer the suppression signal to the sound source module 10 for playing the audio signal, so as to eliminate the interference caused by the ambient noise.

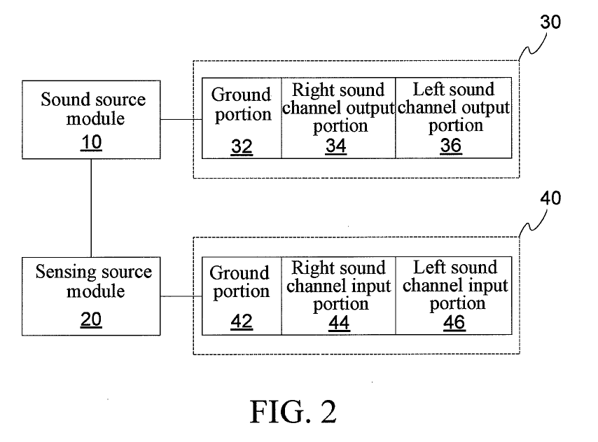

FIG. 2 is a second block diagram of an ANC earphone according to an embodiment. In this embodiment, the first connection module 30 includes a first connector header 31, and the first connector header 31 is a three-stage connector header, i.e., a currently standardized earphone connector header. Herein, since the first connection module 30 is electrically coupled to the sound source module 10 and the sound source module 10 is used for playing the audio signal, the first three-stage connector header 31 includes a ground portion 32, a right channel output portion 34, and a left channel output portion 36. Correspondingly, the host 3 provides the first jack 1 for the first connector header 31 to insert, and the first jack 1 is the earphone jack corresponding to the first connector header 31. In this way, by means of the matching between the first connector header 31 of the first connection module 30 and the first jack 1 of the host 3, the audio signal generated by the host 3 can be transferred to the sound source module 10, so as to be played for a user.

On the other hand, the second connection module 40 includes a second connector header 41, and the second connector header 41 is also a standardized three-stage connector header. Herein, since the second connection module 40 is electrically coupled to the sensing source module 20 and the sensing source module 20 senses the noise for being provided to the host 3 for ANC, the second three-stage connector header 41 includes a ground portion 42, a right channel input portion 44, and a left channel input portion 46. Correspondingly, the host 3 provides the second jack 2 for the second connector header 41 to insert, and the second jack 2 is the microphone jack corresponding to the second connector header 41. In this way, through the matching between the second connector header 41 of the second connection module 40 and the second jack 2 of the host 3, the noise sensed by the sensing source module 20 can be transferred to the host 3 such that the host 3 performs subsequent processing of ANC.

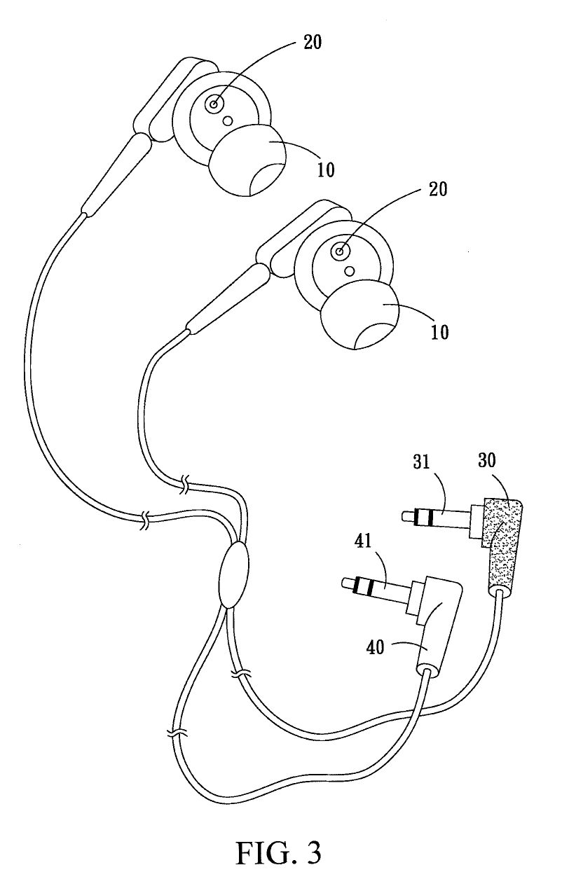

Please refer to FIG. 3, a schematic view of an ANC earphone according to an embodiment. An actual aspect of an embodiment of the ANC earphone provided in the disclosure can be known from FIG. 3. The aforementioned sound source module 10 may be a speaker, the sensing source module 20 may be a sound receiving device, and they are disposed adjacent to each other. In this way, the sensing source module 20 can successfully sense the noise near the sound source module 20. Two standardized three-stage connector headers (i.e., respectively the first connection module 30 and the second connection module 40), are provided at the other ends of connecting lines of the earphone.

Taking an embodiment in which the host 3 is a computer system for illustration, general computer systems usually have multiple standardized three-stage jacks and different jacks are mostly marked by different colors, most of which have also been standardized. For example, a green jack is an earphone jack, while a red jack is a microphone jack. Therefore, for the convenience of the user, in the ANC earphone provided in the disclosure an appearance of the first connection module 30 is marked in green, so that the user can correctly insert the first connector header 31 of the first connection module 30 into the first jack 1 (earphone jack), according to the color marking. On the other hand, an appearance of the second connection module 40 is marked in red, so as to facilitate the user's correct insertion of the second connector header 41 of the second connection module 40 into the second jack 2 (microphone jack), according to the color marking. After correctly connecting the earphone to the host 3, the user can listen the high-quality sound effect provided by the ANC earphone, which effectively alleviates the problem of reception interference caused by ambient noise.

While the disclosure has been described by the way of example and in terms of the preferred embodiments, it is to be understood that the invention not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An active noise cancellation (ANC) earphone, for coupling to a host having a first jack and a second jack, the ANC earphone comprising:
a sound source module, for playing an audio;
a sensing source module, coupled to the sound source module, for sensing a noise near the sound source module;
a first connection module, having one end coupled to the sound source module and the other end inserted in the first jack, for transferring the audio generated by the host to the sound source module; and
a second connection module, having one end coupled to the sensing source module and the other end inserted in the second jack, for transferring the noise sensed by the sensing source module to the host to generate a suppression signal corresponding to the noise for cancelling the noise.

2. The ANC earphone according to claim 1, wherein the first connection module comprises a first connector header, and the first connector header is a three-stage connector header.

3. The ANC earphone according to claim 2, wherein the first connector header comprises a ground portion, a right channel output portion, and a left channel output portion.

4. The ANC earphone according to claim 2, wherein the first jack is an earphone jack corresponding to the first connector header.

5. The ANC earphone according to claim 1, wherein the second connection module comprises a second connector header, and the second connector header is a three-stage connector header.

6. The ANC earphone according to claim 5, wherein the second connector header comprises a ground portion, a right channel input portion, and a left channel input portion.

7. The ANC earphone according to claim 5, wherein the second jack is a microphone jack corresponding to the second connector header.

8. The ANC earphone according to claim 1, wherein the sound source module is a speaker.

9. The ANC earphone according to claim 1, wherein the sensing source module is a sound receiving device.

10. The ANC earphone according to claim 1, wherein an appearance of the first connection module is marked in green.

11. The ANC earphone according to claim 1, wherein an appearance of the second connection module is marked in red.

12. An earphone, for coupling to a host having a first jack and a second jack, the earphone comprising:
a sound source module, for playing an audio;
a sensing source module, coupled to the sound source module, for sensing a noise;
a first connection module, having one end coupled to the sound source module and the other end being a first connector header corresponding to the first jack, wherein the first connection module is used for transferring the audio generated by the host to the sound source module; and
a second connection module, having one end coupled to the sensing source module and the other end being a second connector header corresponding to the second jack, wherein the second connection module is used for transferring the noise sensed by the sensing source module to the host to generate a suppression signal corresponding to the noise for cancelling the noise.

13. The earphone according to claim 12, wherein the first connector header is a three-stage connector header.

14. The earphone according to claim 13, wherein the first connector header comprises a ground portion, a right channel output portion, and a left channel output portion.

15. The earphone according to claim 12, wherein the second connector header is a three-stage connector header.

16. The earphone according to claim 15, wherein the second connector header comprises a ground portion, a right channel input portion, and a left channel input portion.

17. The earphone according to claim 12, wherein the sound source module is a speaker.

18. The earphone according to claim 12, wherein the sensing source module is a sound receiving device.

19. The earphone according to claim 12, wherein an appearance color of the first connection module is different from that of the second connection module.

20. The earphone according to claim 19, wherein an appearance of the first connection module is marked in green, and an appearance of the second connection module is marked in red.
